(19) United States
(12) Patent Application Publication
(10) Pub. No.: US 2011/0273456 A1
(43) Pub. Date: Nov. 10, 2011

(54) SYSTEM AND METHOD FOR PARTIAL SIMULATION AND DYNAMIC CONTROL OF SIZES OF ANIMATED OBJECTS

(75) Inventors: Murilo Coutinho, Los Angeles, CA (US); Rodrigo Ibanez, Hermosa Beach, CA (US)

(73) Assignees: SONY PICTURES TECHNOLOGIES INC., Culver City, CA (US); SONY CORPORATION, Tokyo (JP)

(21) Appl. No.: 13/100,980

(22) Filed: May 4, 2011

Related U.S. Application Data
(60) Provisional application No. 61/331,248, filed on May 4, 2010.

(51) Int. Cl. G06T 13/00

(52) U.S. Cl. 345/473

(57) ABSTRACT

Systems and methods are provided for altering a portion of a simulation without deleteriously altering adjoining portions, and in so doing increasing the pace at which simulations may be made by decreasing the overall number and size of simulations required. In other implementations, the systems and method provide convenient ways to dynamically control the size of animated objects, such as hair or cloth, using animated rest poses.

### CROSS-REFERENCE TO RELATED APPLICATIONS

This application claims benefit of priority of U.S. Provisional Patent Application Ser. No. 61/331,248, filed May 4, 2010, entitled “PARTIAL CLOTH SIMULATIONS”, owned by the assignee of the present invention and incorporated herein by reference in its entirety.

### BACKGROUND

The simulation of hair by a computer is one of the more challenging subfields of computer animation. Prior approaches to solving such simulations were generally laborious and required many iterations to achieve a desired effect. For example, in a production environment, the process of obtaining final approval on a cloth shot is iterative. Referring to a prior art process illustrated by the flowchart 10 of FIG. 1, at early stages, cloth technical directors usually run several simulations from the same basic model or set up, but with significant variations on the values of certain properties (step 12). The property values are then narrowed down to a range that provides a visual effect that matches the desired look of the scene (step 14). The goal of this step is to narrow down the range of values to the ones that best match an artistic direction defined by the director. Once an appropriate range is found, most of the subsequent work is to fine tune the property values to obtain a visual effect that will achieve a final approval (step 16).

The fine tuning step may require global changes as well as local modifications of numerous types. For example, a director may require larger wrinkles on a character's clothing in the knee area, but may otherwise desire that the rest of the animation stay the same. Such alterations may be problematic, because altering the property values so as to “fix” one region of the cloth generally results in undesiredly affecting the look of the already-approved regions.

One solution used by cloth technical directors is to use cloth cache compositor software to combine the localized simulation results with each other to create a final shot with all desired local changes. This process is cost inefficient because localized modifications still require a full simulation of the entire garment, even though just a subset of the result is needed.

### SUMMARY

Systems and methods according to the principles of the invention allow users to specify portions of an animated object, such as cloth, to be simulated while allowing other portions to be maintained unsimulated. In this way, the results of a prior simulation are not disturbed when adjusting property values on a portion to be re-simulated.

In one implementation, users may “paint” a map on a cloth mesh, designating a portion of the cloth mesh, i.e., a subset of control vertices, indicating which vertices of the cloth mesh need re-simulation. A vertex with a map value of one will be fully simulated, whereas a value of zero means that the vertex will not be simulated.

The system may provide a number of ways of specifying how to treat vertices that are not simulated. In one way, a cloth technical director can provide a path to an existing simulation cache, allowing the system to reuse the result of a previous simulation on the regions that should not be affected by future property value adjustments. In another way, if no cache path is provided, the system may use a goal or input mesh associated with the cloth object to define the positions of the “not simulated” vertices for the partial simulation. For example, a goal or input mesh may have an animated cloth bound to it, e.g., skin-bound or body-bound, and the same may be employed to create an animation to combine with the simulation to achieve a final result.

The system may also provide for blended simulations, where the final result is a blend, e.g., a weighted blend, of a simulation and a cached or created animation. For example, a vertex map value between zero and one may indicate that the vertex requires simulation but that its final position is to be determined by a blend between the simulated and the “not simulated” positions, using the painted map value or “vertex value” as the blend weight or “first weighting”.

Efficiency may be improved even further by outputting two caches: one saves the actual simulation results, and the other stores a set of displayed results including the blend (the displayed results can differ from the results of the blend as the former generally have unphysical or undesirable results repaired). As both sets of results are then available for use in calculations, a cloth technical director can vary the blend weight on the vertices (termed here a “second weighting”) that were simulated to achieve a different appearance without having to re-simulate the entire shot.

In another method, an animated rest mesh may be associated with an object such as a hair or cloth object during a simulation. A rest pose may be employed to specify the rest lengths of all springs defining the physical model of the object. By animating the rest pose, the size of the object can be dynamically altered. For example, hair may be shorted or cloth lengthened. This aspect may be particularly useful in cartoon motions, e.g., where character arms are stretched while simulated sleeves of a shirt are adjusted accordingly.

In one aspect, the invention is directed to a method of graphically simulating at least a portion of an object, including: designating a portion of an object to be simulated; altering a property value associated with the portion; simulating the designated portion using the altered property value; retrieving or creating an animation corresponding to portions of the object not simulated; and combining the simulated portion and the retrieved or created animation.

Implementations of the method may include one or more of the following. The designating a portion of an object to be simulated may include designating a plurality of control vertices within the object, and the control vertices may be associated with control curves or control surfaces. The altering a property value may include altering a variable selected from the group consisting of: stiffness, damping, and density, for physical properties; and friction, constraints, and force fields, for collision properties. The retrieving may include retrieving a cached result of a prior simulation or may include retrieving a goal or input mesh and creating an animation based on the goal or input mesh.

In another aspect, the invention is directed to a non-transitory computer-readable medium, including instructions for causing a computing system to perform the above method.

In another aspect, the invention is directed to a method of graphically simulating at least a portion of an object, including: designating at least a portion of an object to be partially simulated and a first weighting to be associated with the simulation; retrieving or creating an animation corresponding to the designated portion; simulating the designated portion; and blending the retrieved or created animation with the simulation to obtain a final blend, the simulation weighted by the first weighting.

Implementations of the invention may one or more of the following. The designating a portion of an object to be simulated may include designating a plurality of control vertices within the object, and the control vertices may be associated with control curves or control surfaces. The simulating may include altering a property value associated with the portion. The retrieving may include retrieving a cached result of a prior simulation or may include retrieving a goal or input mesh and creating an animation based on the goal or input mesh. The method may further include designating another portion of the object to be fully simulated, and may further include combining the fully simulated portion with the final blend to obtain a final result. The method may further include retrieving or creating an animation corresponding to portions of the object not simulated or partially simulated, and may further include combining the retrieved or created animation with the final blend to obtain a final result. The method may further include retrieving or creating an animation corresponding to portions of the object not simulated or partially simulated, and may further include combining the retrieved or created animation with the final blend and with the fully simulated portion to obtain a final result. The method may further include combining the simulation with the final blend according to a second weighting. The first or second weighting may be between zero and one. The first or second weighting may be a function of location on the portion of an object to be partially simulated, and the function may be a continuous function in each dimension.

In another aspect, the invention is directed to a non-transitory computer-readable medium, including instructions for causing a computing system to perform the above method.

Advantages may include one or more of the following. The systems and methods may significantly improve work flow and reduce the cost of animating objects, e.g., cloth, and are convenient to implement within a simulation engine. Rather than employing a standard point-to-point blend, the system and method may provide blends that are collision aware and provide valid non-intersecting cloth states. All collisions with non-simulated vertex regions are properly resolved because all object regions not being simulated are still used as collision objects to the partially simulated vertices and any other object layers present in the shot.

Other advantages will be apparent from the following description, including the figures and claims.

### BRIEF DESCRIPTION OF THE DRAWINGS

FIG. 1 is a flowchart illustrating a prior art method to perform a cloth simulation;

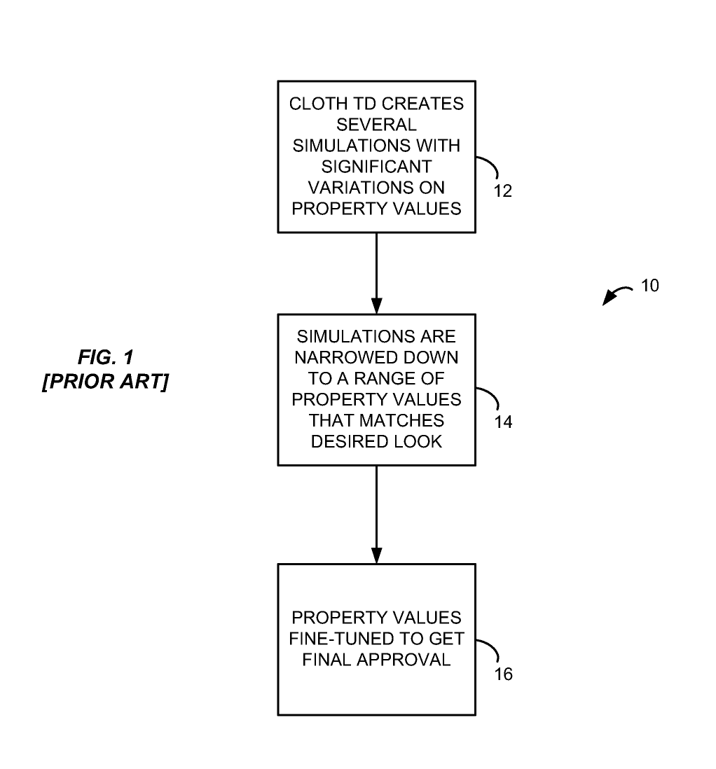

FIGS. 2(A) and 2(B) are schematic illustrations of an exemplary model according to an implementation of the present invention, showing a control surface as well as a portion of a body object indicating a region for resimulation;

FIG. 3 is a flowchart illustrating an implementation of a method of the present invention;

FIGS. 4(A) and 4(B) are schematic illustrations of an exemplary model according to an implementation of the present invention, showing portions that are non-simulated (weighting=zero) and portions that are fully simulated (weighting=one) both before (A) and after (B) resimulation;

FIGS. 5(A) and 5(B) are schematic illustrations of an exemplary model according to an implementation of the present invention, showing portions that are non-simulated (weighting=zero), portions that are fully simulated (weighting=one), and portions that are blended, i.e., formed from a blend of simulated and non-simulated portions (0<weighting<1), both before (A) and after (B) resimulation;

FIG. 6 illustrates an exemplary structure of a computing device that may be employed to implement one or more of the partial simulation features described herein;

FIG. 7 illustrates another exemplary structure of a computing device that may be employed to implement one or more of the partial simulation features described herein;

FIG. 8 is a flowchart illustrating an implementation of another method of the present invention;

FIGS. 9(A)-(C) are schematic illustrations of an exemplary model according to an implementation of the present invention, showing a rest pose (A), an expanded pose with rest lengths uniformly expanded (B), and an expanded pose with rest lengths non-uniformly expanded (C);

FIG. 10 illustrates an exemplary structure of a computing device that may be employed to implement one or more of the dynamic sizing features described herein;

FIG. 11 illustrates another exemplary structure of a computing device that may be employed to implement one or more of the dynamic sizing features described herein; and

FIG. 12 illustrates yet another exemplary structure of a computing device that may be employed to implement one or more of the features described herein.

Like reference numerals indicate like elements in the drawings. Elements are not drawn to scale unless otherwise indicated.

### DETAILED DESCRIPTION

Systems and methods are disclosed which in some implementations provide convenient and inexpensive ways to alter a portion of a simulation without deleteriously altering adjoining portions. In other implementations, the systems and method provide convenient ways to dynamically control the size of animated objects, such as hair or cloth, using animated rest poses.

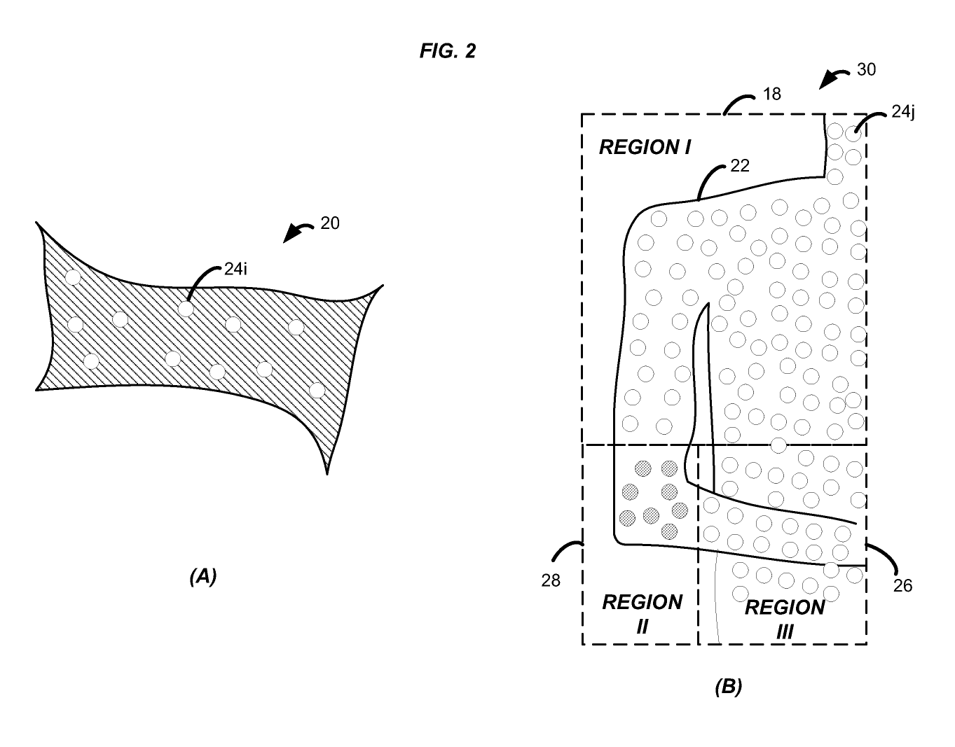

Referring to FIG. 2(A), a control surface 20 is illustrated having a number of control vertices 24i. Control surfaces are generally applicable to the case where cloth is being modeled, but it will be understood that the systems and methods according to implementations of the present invention may be employed for any type of animated object, e.g., hair. In the case of hair, control curves instead of control surfaces may be employed. Other variations will also be seen.

The generation of control surfaces and control vertices may form the initial steps in which a given animated object is modeled. In some cases, however, control entities and control vertices may have been formed during the generation of an underlying model for the animated object.

FIG. 2(B) illustrates an exemplary portion 30 of an animation, including an object 22, in this case a character's clothed upper body portion and arm. The object 22 includes a number of control vertices 24j which represent the character's garment. These vertices form a control surface that is atop a character body model. It is noted that while object 22 is a cloth object, other sorts of objects may also pertain to the described implementations. In addition, other portions of the character, including body portions, are not indicated in FIG. 2(B) for clarity.

The portion 30 has been divided by a user into a number of regions. Region I is denoted by region 18, region II is denoted by region 28, and region III is denoted by region 26. In this example, regions I and III have been designated to be non-simulated, and region II is designated to be simulated (shaded control vertices). For example, region II may have been simulated (as may regions I and III) but require resimulation because the folds in the elbow section may not appear as desired. Regions I and III thus include control vertices that are assigned a vertex value of zero, also called a first weighting, and Region II vertices are assigned vertex values of one. By resimulating only region II, computational resources are only allocated to that limited region, as opposed to resimulating the entire object. Limiting the region of resimulating results in more rapid and cost-efficient simulations, as fully simulating objects is computer resource-intensive, as the same must calculate generally large modeled systems acting under the influence of springs, gravity, and numerous other forces and influences, including collision rules.

It is noted that, in a final animation, regions I and III may well include simulated portions, but such will generally not be solved in the same steps as region II. Rather, regions I and III may be drawn from prior simulations or may be created as a new animation. For example, regions I and III may be created from an input or goal mesh, e.g., with a cloth layer bound thereto.

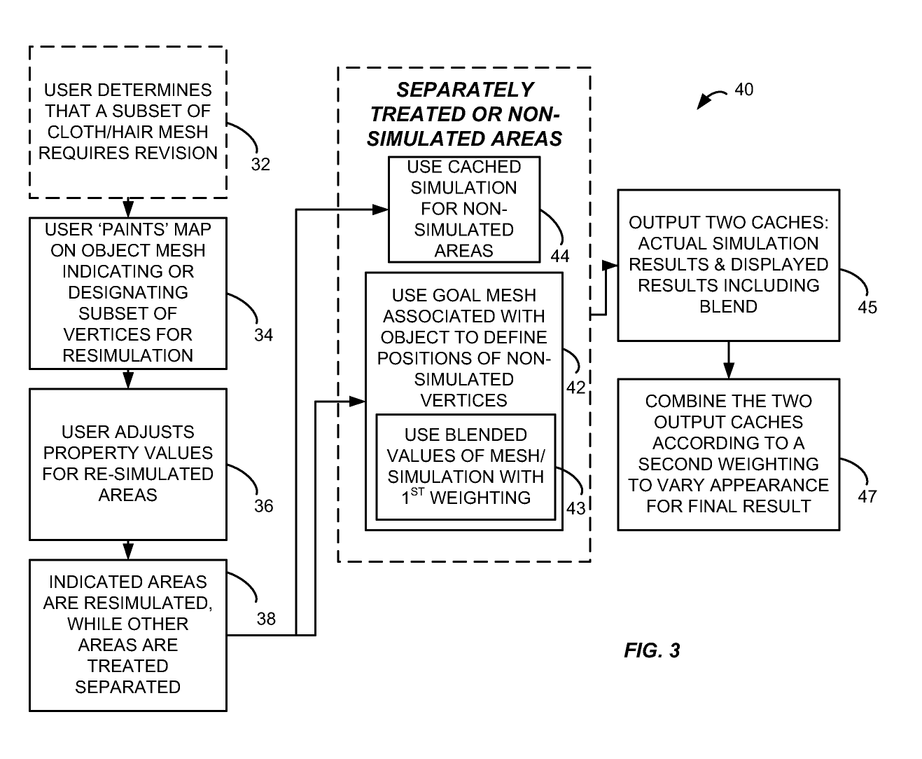

Referring to FIG. 3, a flowchart 40 is shown illustrating an exemplary implementation of the method of the invention. A first step is that a user determines that a subset of an animated object, e.g., cloth or hair, requires revision (step 32). For example, as noted above, a user may determine that a particular section of an animated object does not appear as desired.

A next step is that a user “paints” a map on the object mesh indicating or designating a subset of vertices for re-simulation (step 34). For example, in this subset, the vertices may be given a vertex value of one while nonsimulated vertices may be assigned a vertex value of zero. The user may then adjust the property values in which re-simulation will occur (step 36). Such property values may include those pertaining to spring stiffness, compression, or the like. The simulation may then be run, with control vertices having vertex values of one resimulated (step 38). Control vertices with other vertex values, e.g., zero, are treated separately.

Separately-treated areas are processed by steps 42-44 shown in the dotted box. In one implementation, cached simulation results are retrieved and employed in creating the animation for the non-simulated areas (step 44). The same may be from prior simulation results or other results that otherwise fit the simulation in a desired way. In another method, a goal or input mesh associated with the animated object is employed to define the positions of the non-simulated vertices (step 42). In some cases, the goal mesh is modified for this purpose, such as to serve as the basis for a cloth object that is bound to the goal mesh.

In a related implementation, the goal mesh is employed but used in a blend along with a simulation (step 43). In other words, the goal mesh may be combined with the simulated results using a fractional first weighting, e.g., 0.5. In this way, the technical director can choose, by varying the fractional first weighting, how much of the simulated result appears in the scene vis-a-vis how much of the result is based on other techniques, e.g., based on the goal or input mesh. The final scene may be heavily weighted towards the simulation, heavily weighted towards other types of animations or prior simulations, or anywhere in-between. Using such a system allows for significant flexibility in creating particularly smooth and continuous animations.

To achieve even greater flexibility, two separate caches may be output (step 45): one output cache may include actual simulation results, and another may include the displayed results including the weighted blend. In this way, as the combined caches include simulated results and non-simulated results, the technical director may combine the two using any weighting, termed a second weighting, to achieve the desired final appearance without the need for any additional re-simulation (step 47).

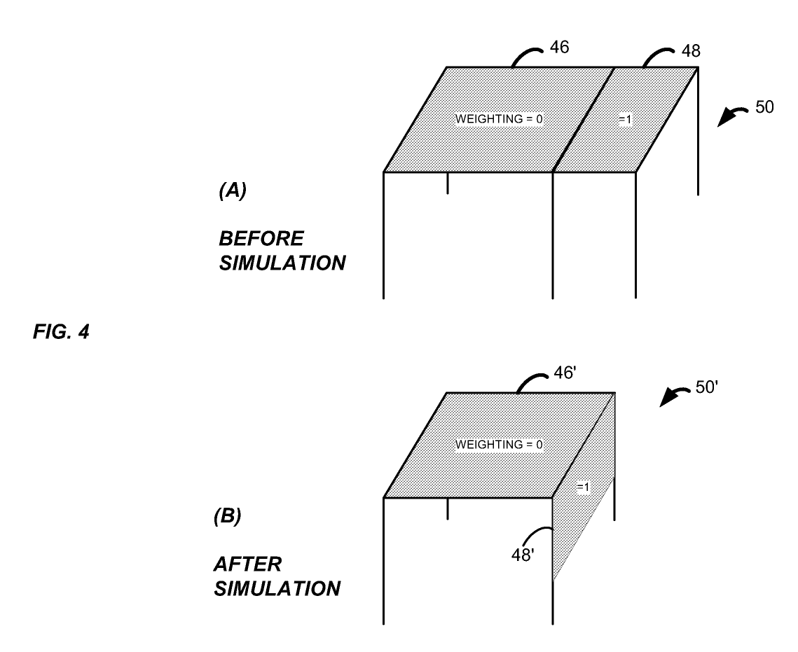

FIGS. 4(A) and (B) illustrate an exemplary situation, showing the effects of simulation and non-simulation. FIG. 4(A) illustrates the situation before the simulation, and FIG. 4(B) illustrates the situation after. In the former, a control surface 50 is illustrated which may represent any sort of continuous planar object, such as a cloth, a table, or the like. A left portion 46 of control surface 50 has been assigned a weighting of zero, and a right portion 48 of control surface 50, connected to the left portion 46, has been assigned a weighting of one. Following simulation, as shown in FIG. 4(B), the portion assigned a weighting of zero, i.e., left portion 46, is shown to have undergone no transformation. Because of the zero weighting value, no simulation was performed, and the surface stays the way it was before. However, the control surface 50, after simulation termed control surface 50′, has a right portion 48 that, under simulation, has flipped down under the effect of gravity. That is, the right portion 48 has been simulated and under the simulation conditions, which may include effects of gravity, collisions, or the like, has caused the right portion 48 to undergo a transformation.

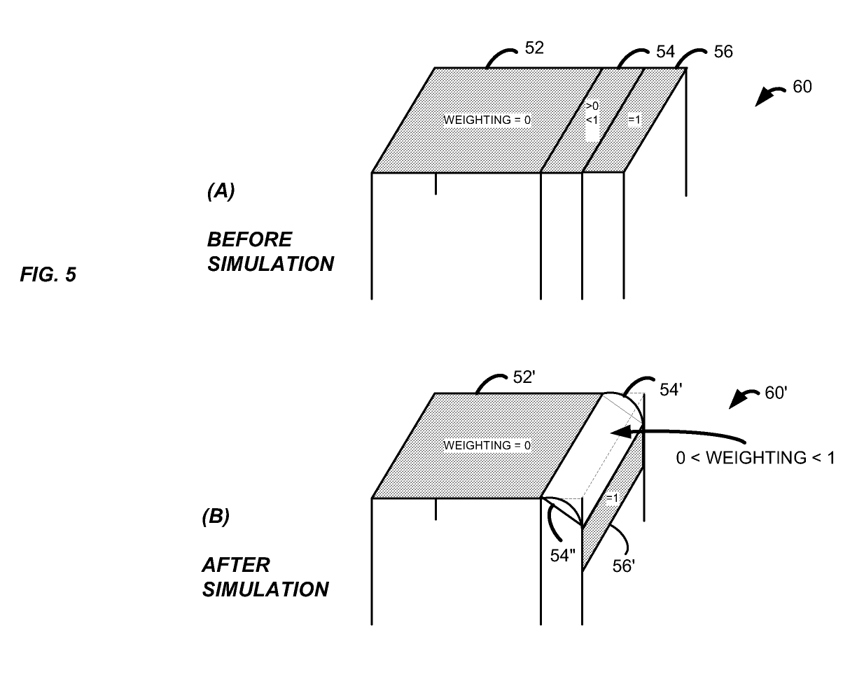

FIGS. 5(A) and (B) illustrate another exemplary simulation, but in this case a blend is provided in one portion of the control surface, the blend being a combination of non-simulated and simulated results. As before, FIG. 5(A) illustrates the situation before the simulation, and FIG. 5(B) illustrates the situation after. In the former, a control surface 50 is again illustrated which may represent any sort of continuous planar object. A left portion 52 of control surface 60 has been assigned a weighting of zero; a middle portion 54 of control surface 60, connected to the left portion 52, has been assigned a finite (but less than one) vertex value; and a right portion 56 of control surface 60, connected to the middle portion 54, has been assigned a weighting of one. Consequently, the left portion 52 will remain non-simulated, the middle portion 54 will be calculated by a blend, as will be described below, and the right portion 56 will be fully simulated.

Following simulation, as shown in FIG. 5(B), the portion assigned a weighting of zero, i.e., left portion 52, is shown to have undergone no transformation. Because of the zero weighting value, no simulation was performed, and the surface stays as it was before. However, the control surface 60, after simulation termed control surface 60′, again is seen to have the right portion 56 act such that, under simulation, flips down under the effect of gravity.

The middle portion 54 acts in an intermediate fashion, and this middle portion is post-simulation termed middle portion 54′. While the same may vary in shape, the middle portion is exemplified in FIG. 5(B) by a curved corner 54′. The middle portion may also be straight, and the same is illustrated by line 54″. Other variations will also be seen, as the shape of the middle portion is essentially arbitrary. For clarity, this section is not shaded in the figure so that details may be seen. It will be understood that any number of types of curves may be possible for middle portion 54, according to the type of function through which the first weighting varies. The function is arbitrary, but may often be employed to diminish the occurrence of sharp edges and the like. For example, a linear first weighting would result in line 54″, and higher-order first weightings would result in curve 54′, and so on. The function may vary by location on the object, and is often implemented so as to vary in a continuous manner, e.g., in a given direction or dimension.

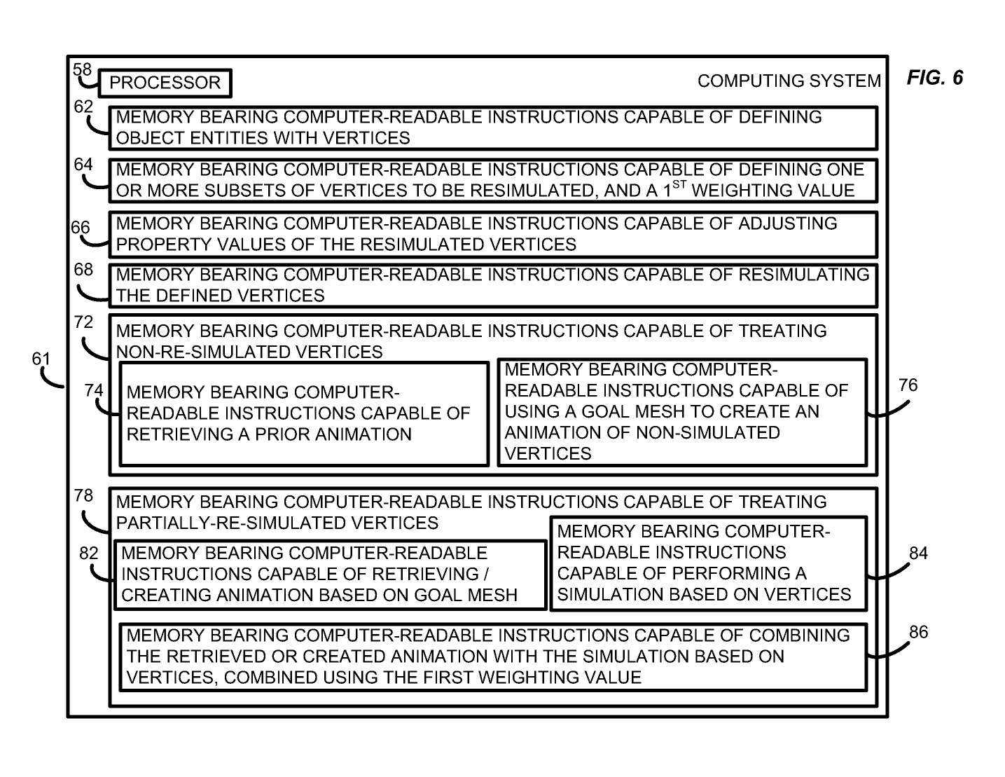

FIG. 6 illustrates a first exemplary structure of a computing system 61 that may be employed to implement one or more of the features described herein, and may correspond to, e.g., an animation workstation. The computing system 61 includes a processor 58 and also includes memory 62 bearing computer-readable instructions capable of defining or retrieving an animated object to be simulated having control vertices. The computing system 61 further includes memory 64 bearing computer-readable instructions capable of defining one or more subsets of vertices to be simulated, and a first weighting value. For example, the first weighting value may be a number between zero and one inclusive, where zero indicates no simulation and one indicates full simulation. The computing system 61 may further include memory 66 bearing computer-readable instructions capable of adjusting one or more of the property values of the animated object having control vertices to be simulated. For example, it may be desired to increase the number of wrinkles in a cloth in a designated area. The amount of fabric in that area may consequently be caused to increase so as to provide the extra surface area for the extra wrinkles. The computing system 61 may also include memory 72 bearing computer-readable instructions capable of treating vertices that are not undergoing a new simulation. The same may include memory 74 bearing computer readable instructions capable of retrieving the results of a prior simulation, or a portion of the results, so as to allow the same to be employed in non-resimulated areas. The same may include also include memory 76 bearing computer readable instructions capable of creating or retrieving another animation to use in the non-simulated areas, such as by using a goal mesh to create an animation based on the non-simulated vertices. The goal mesh may be used as discussed above, where an animated cloth object is bound to the goal mesh.

The computing system 61 may also include memory 78 bearing computer-readable instructions capable of treating vertices using a blended simulation. For example, vertices may be used to create an animation as discussed above in connection with memory 76, and may also be used in a simulation. Blending these two types of results provides even greater flexibility for a technical director. Accordingly, memory 82 may be provided bearing computer readable instructions capable of retrieving or creating an animation, and memory 84 may be provided bearing computer readable instructions capable of performing a simulation based on the same vertices. The memory 86 may then be employed bearing computer readable instructions capable of blending the retrieved or created animation with the simulation based on the vertices, and the two may be combined based on the first weighting value. In this way, a high degree of flexibility is achieved in modifying the appearance of a given animation.

Other memories may also be employed, these not shown in FIG. 6. For example, memories may be provided that allow the results of the simulation and the results of the blend to be combined in any number of ways, such as by the use of a second weighting, to allow the technical director even more flexibility in obtaining a desired final result, without the need for running a resimulation. It will be understood that other memories may be employed to bear other pertinent information, instructions, and data.

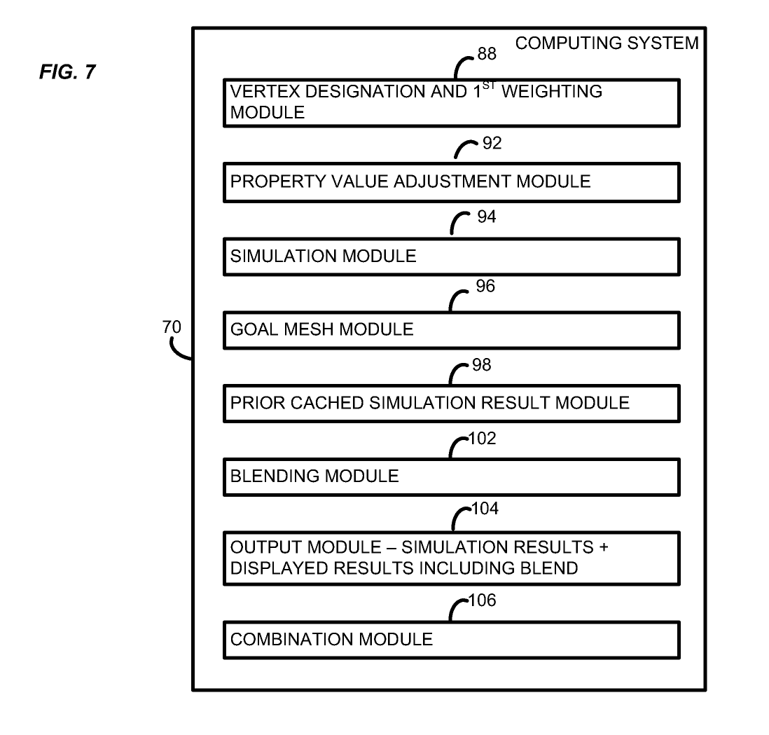

FIG. 7 illustrates a second exemplary structure of a computing system 70 that may be employed to implement one or more of the features described herein. The computing system 70 includes a control vertex designation and first weighting module 88. The module 88 may be employed to designate the subset of vertices, i.e. the portion of the object, to be re-simulated. The computing system 70 may further include a property value adjustment module 92, through which various graphical properties of the animated object may be adjusted to provide the appearance desired by the director. The computing system 70 may further include a simulation module 94 through which simulations and re-simulations are run. The computing system 70 may further include a goal mesh module 96, the same storing and providing a goal mesh for use in creating an animation, particularly for non-simulated portions of the object. The computing system 70 may further include a prior cached simulation result module 98, through which the results of a prior simulation may be retrieved and used for non-simulated portions of the object. The computing system 70 may further include a blending module 102, through which blended simulations may occur, in which simulated results and non-simulated results are combined according to a first weighting. The computing device 70 may further include output module 104, which may output several caches, including a cache with direct simulation results and a cache with the displayed results including the blend. The various outputs may be combined in a combination module 106. The combination module 106 may combine the prior cached information with the simulation, the simulation with the blended results, or may combine any other sets of results. For example, in the case where the combination module 106 combines the simulation with the blended results, a second weighting may be employed to provide an emphasis for one of the two sets of results in the final result.

Variations of the computing system 70 will be apparent given this teaching. For example, not all of the modules need be located on a single system. In some cases, most or all of the modules may be on separate systems. The same is true for other modular computer environments described in the application.

The control and manipulation of control vertices may be employed to conveniently provide other features. For example, by associating a set of control vertices of an object, and a position of the object, with a rest pose, various features may be provided, such as dynamic sizing of objects or portions thereof.

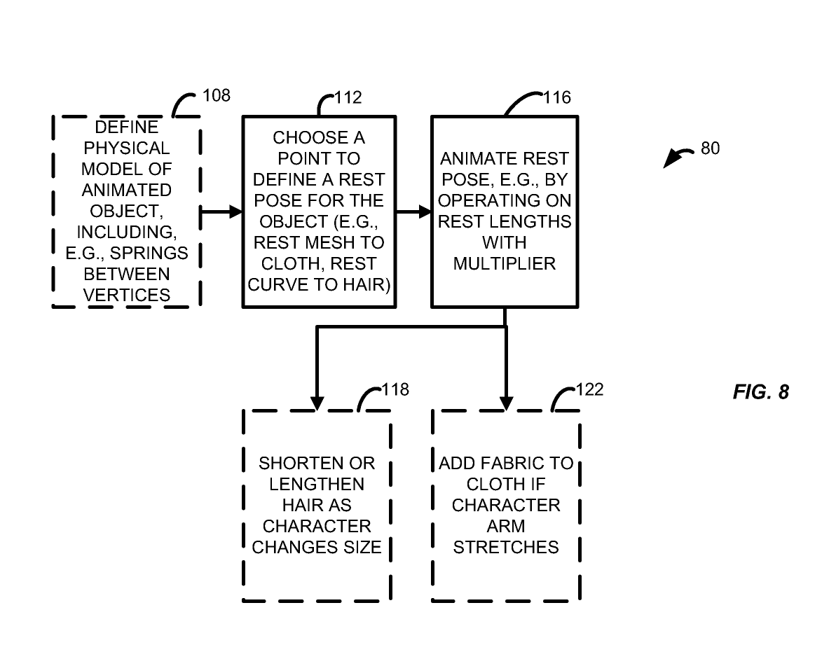

FIG. 8 illustrates a flowchart 80 which may be employed to implement a dynamic sizing method according to the described principles. A first step is the definition of a model of the animated object using control vertices and including, e.g., springs or other modeled devices between the control vertices (step 108). In many cases, such control vertices may have already been defined as part of the definition of the underlying animated object. A next step is to define a rest pose of a rest mesh (step 112). In this step, a point in the animation is chosen at which a rest pose and mesh may be conveniently defined. The same may be often (though not exclusively) associated with a default or common pose in the animation, and one that embodies a common character size or pose. The rest pose may also be defined as one that minimizes the cumulative extension and compression of springs in the model, in the case where the model is defined by a spring system. Any of such provisions may allow a more consistent multiplier to be applied at later points in the animation.

Instead of a static rest mesh, which merely keeps distances between points at some level so that the object, e.g., cloth, does not scale in an undesired way, the rest mesh defined above may scale with the simulation, i.e., animate with the character, so as to achieve a desired result.

To achieve this desired scaling, one or more of the springs (or other devices) in the system may then be operated on by a multiplier in one or more directions or dimensions (step 116). The size of the animated object is then changed according to the effect of the multiplier. Such a step then allows the size of the object to be easily modified in the one or more dimensions by the amount of the multiplier. For example, if the multiplier is two, the size of the object increases by two. Such a method may be conveniently employed in the case where an underlying body object is caused to increase in size, e.g., an arm stretching, but where a cloth object covering the body object would otherwise undesiredly stay the same size.

Certain manifestations of step 116 are illustrated by steps 118 and/or 122. For example, the length of a character's hair may be caused to shorten or lengthen as a character changes size (step 118). Similarly, fabric may be caused to lengthen as a character's arm stretches (step 122). Numerous examples will be apparent to one of ordinary skill in the art given this teaching.

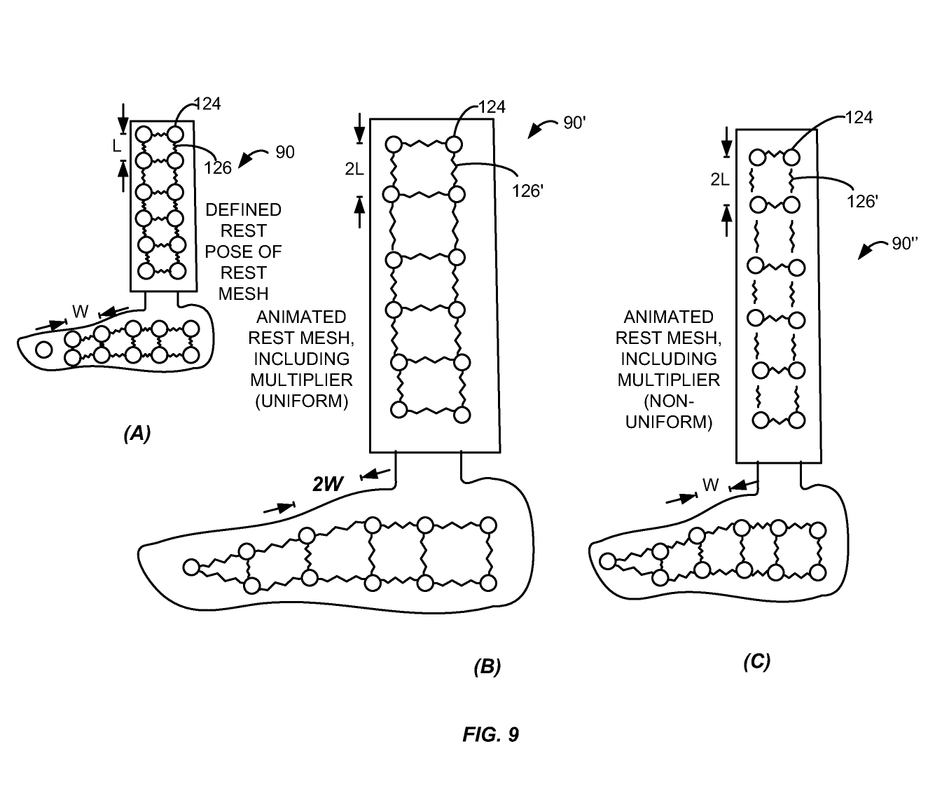

Illustrations of this behavior are shown in FIGS. 9(A)-(C). In FIG. 9(A), a rest pose 90 of a bottom portion of an animated leg and foot is shown, the leg having trousers. The rest pose 90 includes a number of control vertices 124 separated by springs 126. The control vertices are generally and approximately separated by a distance L in a vertical direction and a distance W in a horizontal direction. A multiplier of approximately two is applied in this example, leading to the result 90′ in FIG. 9(B), in which the leg, foot, and trousers are generally doubled in size in each of the two planar directions. In this way, the vertical and horizontal distances, i.e., length of springs 126′ between control vertices, uniformly become 2L and 2W, respectively. The use of the prime in this instance is to denote that springs 126′ are animated while springs 126 pertain to the rest pose. In FIG. 9(C), a nonuniform multiplier has been applied, leading to vertical distances of springs 126′ between control vertices substantially doubled to 2L but horizontal distances staying approximately the same at W.

When the distance has been altered, the accompanying spring constant may be altered (or not) for a desired effect. In many cases, altering the spring constant allows for the resulting animation to have a more believable appearance. In many such cases, it is appropriate to scale the spring constant so that the overall stiffness remains the same, resulting in similar model behavior. In the same way, where simulations have a mass associated with the object, it may be appropriate to alter the mass associated with each control vertex (or by any other measure) so that the character weight, which may otherwise scale with the rest mesh, does not cause problems in the simulation. For example, doubling a character's size may result in a character than can no longer move easily. By lessening the mass, e.g., halving the mass associated with each control vertex, the character may regain mobility.

Once the rest mesh has been scaled, the result is often simply resized cloth with edge lengths matching that of an underlying rest mesh. Realistic-appearing effects may then be achieved by allowing a simulation to occur on the resized cloth. It is important to note that in certain implementations, the calculation and use of a scaled rest mesh is computed on a per-frame basis. That is, at every frame, the calculation of the rest mesh may be performed anew. This dynamic resizing allows the cloth to grow and shrink on a stretch—squash type of motion characteristic of cartoon animation.

The rest mesh resizing may allow the convenient achievement of other desired effects. For example, in one exemplary implementation, it may be desired to provide extra cloth to have a section of clothing appear loose. The desired cloth section may be increased in size, while maintaining the character body animation to remain the same, resulting in the desired effect. In another example, a character's clothing may be kept body-bound, i.e., “tight” against the body, while a belly section and belt may be made looser, again achieving the desired effect.

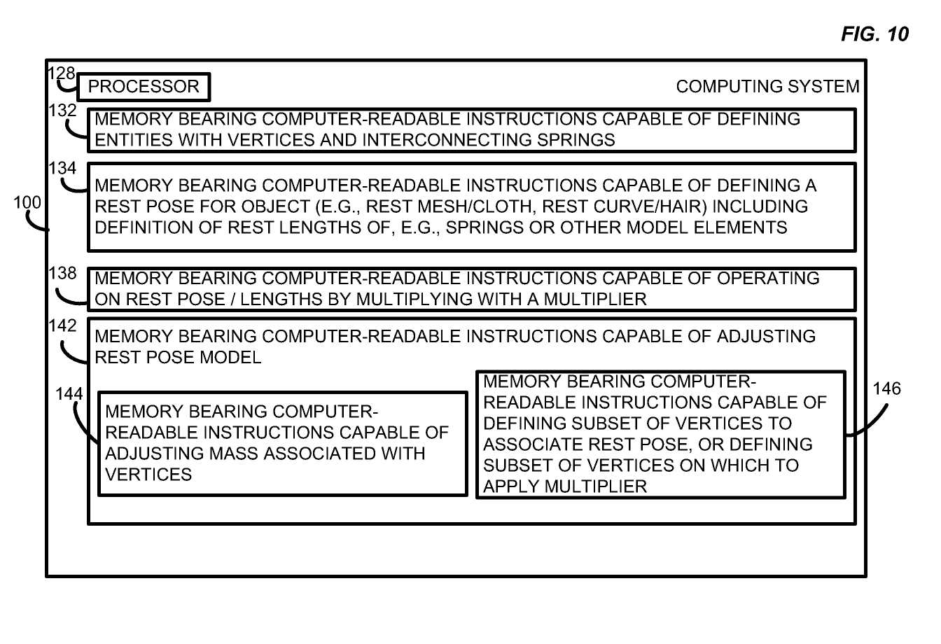

FIG. 10 illustrates an exemplary computing system or environment 100 in which certain features of the invention may be implemented. The computing system 100 includes a processor 128 and memory 132 bearing computer-readable instructions capable of defining entities with vertices and interconnecting springs. Other model elements connecting vertices may also be employed. The entities are generally animated objects, and the vertices define points that constitute the objects. The interconnecting springs connect control vertices, and generally connect nearest neighbor control vertices. Of course, it will be understood that any order may be employed so long as sufficient computing power is available to resolve the model. That is, 2^{nd} nearest neighbors, 3^{rd} nearest neighbors, or others may be taken into account. It is noted however that even if significant computing capacity were available, models with overly large numbers of springs may lead to unstable situations.

The computing system 100 may also include memory 134 bearing computer-readable instructions capable of defining a rest pose for the object. The rest pose may be based on a common pose taken by the object, and may generally correspond to the animated object when the same is not undergoing substantial deformation or the like. For cloth, the rest pose may be associated with a rest mesh; for hair, a rest curve may be associated therewith. Other variations will also be seen.

The computing system 100 may also include memory 138 bearing computer-readable instructions capable of operating on the rest pose with a multiplier, so as to increase the rest length of at least a subset of the springs or the other model elements between control vertices. The multiplier may be greater than unity for expansions and less than unity for compressions, and the multiplier may act in one, two, or all three dimensions.

The computing system 100 may also include memory 142 bearing computer-readable instructions capable of fine-tuning or adjusting the rest pose model, and such may include any of the features noted above. For example, such memory may include a memory 144 bearing computer-readable instructions capable of adjusting a mass associated with each vertex or otherwise associated with the object. In this way, deleterious mass effects associated with resized volumes or surface areas may be negated.

The computing system 100 may also include memory 146 bearing computer-readable instructions capable of defining a subset of vertices with which to associate a rest pose, or a subset of vertices on which to apply the multiplier. In connection with memory 146, it is noted that a rest pose need not be associated with an entire object—just a portion of an object may have a rest pose associated therewith. Similarly, only a subset of vertices may be chosen or selected on which to operate the multiplier. In this way, desired object features may be resized while others are not.

Other memories may also be employed, for the same reasons noted above in connection with FIG. 6.

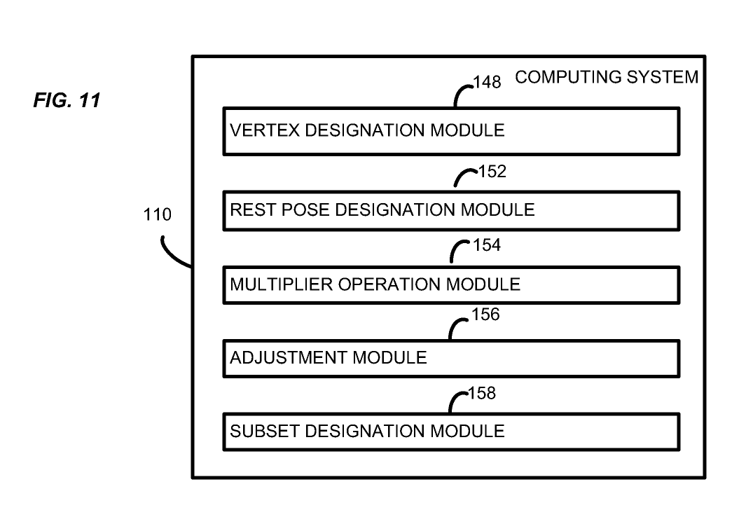

FIG. 11 illustrates another exemplary structure of a computing system 110 that may be employed to implement one or more of the features described herein. The computing system 110 includes a control vertex designation module 148. The module 148 may be employed to designate or define control vertices as part of an animated object, though it is noted that this step may have been performed well-prior to the action of the remainder of the modules described below. The computing system 110 may further include a rest pose designation module 152, through which at least a portion of the object be associated with a rest pose, the rest pose indicating a given position of the object without an overly-large cumulative value of spring compression or expansion. The threshold amount of increase of spring compression or expansion, less than which may provide an appropriate rest pose, may be any desired number according to the dictates of the system, such as 5%, 10%_{,} 15%_{,} 20%, and so on. In one example, the value may be calculated as a minimum of the sum of the absolute values of the displacement of the springs from their zero or rest positions. The point at which the minimum occurs may be defined as the rest pose.

The computing system 110 may further include a multiplier operation module 154 through which distances between control vertices, in many models associated with spring lengths, may be modified. The modification occurs by replacing the prior length with the product of the multiplier and the prior length. The computing system 110 may further include an adjustment module 156, which may be employed for a number of reasons, including to adjust the mass associated with portions of the object, or for any other fine-tuning or adjustment steps that may be required to match a director's artistic vision for the scene. The computing system 110 may further include a subset designation module 158, which may be employed designate a portion of the animated object to have a rest pose, or may alternatively or in combination designate a portion of a rest mesh on which to apply the multiplier. In this way, greater flexibility is achieved for the technical director.

Systems and methods have been disclosed which in some implementations provide convenient and inexpensive ways to alter a portion of a simulation without altering adjoining portions. In other implementations, the systems and methods provide convenient ways to dynamically control the size of animated objects, such as hair or cloth, using animated rest poses. Using the systems and methods, workflows may be significantly improved and costs significantly lowered.

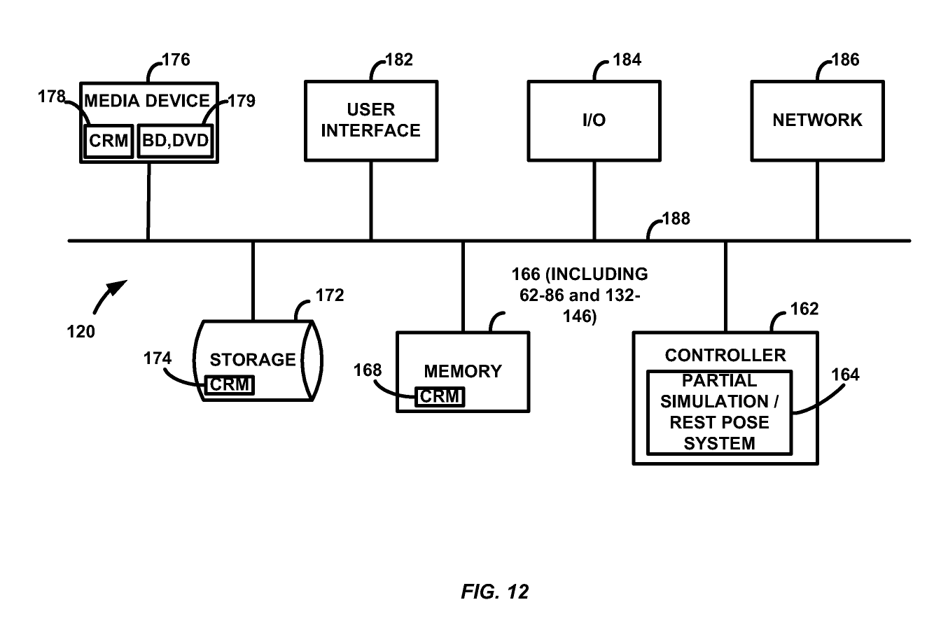

One implementation includes one or more programmable processors and corresponding computer system components to store and execute computer instructions, such as to provide an animation workstation or the like. For example, referring to FIG. 12, a representation is shown of an exemplary computing system 120, which may represent any of computing systems 60, 70, 100, 110 or the like. The system 120 includes a memory 166, which may include computer-readable media 168 such as memories 62-86 and 132-146 (see FIGS. 6 and 10). The system 120 may also include a storage area 172, which may include a computer-readable medium 174, a media device 176 for receiving a computer-readable medium 178 such as BD or DVD 179, a user interface 182, an input/output (I/O) interface 184, and a network interface 186 for connection to online resources. These components are interconnected by a common bus 188. Alternatively, different connection configurations can be used, such as a star pattern with the controller at the center.

A controller 162, which may include the processors 58 and 128 (see FIGS. 6 and 10), controls the operation of the system 120 and its components. The controller 162 loads instructions from the memory 166 or an embedded controller memory (not shown) and executes these instructions to control the system. In its execution, the controller 162 may provide the system 164 for partial simulations or for dynamic control of object sizes in a simulation. Alternatively, this service can be implemented as separate components in the system 120.

The memory 166 stores data temporarily for use by the other components of the system 120, such as for storing the simulation and blends as well as goal and input meshes and rest poses. In one implementation, memory 166 is implemented as RAM. In some implementations, memory 166 also includes long-term or permanent memory, such as flash memory and/or ROM.

The storage area 172 stores data temporarily or long term for use by other components of the system 120, such as for storing data used by the system for running the simulation. In one implementation, storage 172 is a hard disc drive. In another, storage 172 is a solid state drive or includes flash memory or the like. Other storage devices will also be understood, including cloud-based storage.

The media device 176 receives removable media and reads and/or writes data to the inserted media. In one implementation, the media device 176 is an optical disc drive or disc burner 179 such as a Blu-ray® drive.

The user interface 182 includes components for accepting user input from the user of the system 120 and for presenting information to the user. In one implementation, the user interface 182 includes a keyboard, a mouse, audio speakers, and a display.

The I/O interface 184 includes one or more I/O ports to connect to corresponding I/O devices, such as external storage or supplemental devices, e.g., a printer or a PDA. In one implementation, the ports of the I/O interface 184 include ports such as: USB ports, PCMCIA ports, serial ports, and/or parallel ports. In another implementation, the I/O interface 184 includes an interface for wireless communication with external devices.

The network interface 186 includes a wired and/or wireless network connection, such as an RJ-45, or WiFi interface (802.11), or an Ethernet connection. Numerous other types of network connections will be understood to be possible, including WiMax, 3G or 4G, satellite, Bluetooth®, or the like.

The system 120 includes additional hardware and software typical of computing devices, e.g., power, cooling, and operating system, though these components are not specifically shown in the figure for simplicity. In other implementations, different configurations of the device can be used, e.g., different bus or storage configurations or a multi-processor configuration.

While the arrangement has been described with respect to a computing device that is an animation workstation, it is to be understood that the arrangement may be implemented in any number of computing devices, including laptop computers, desktop computers, tablet computers, handheld computers, mobile phones, smart phones, and the like.

The examples above are illustrative and not limiting, and variations of the method and system will be understood by one of ordinary skill in the art, given this teaching. Accordingly, the technology is not limited to the specific examples discussed above, which are provided only as example forms of implementing the claims.

1. A method of graphically simulating at least a portion of an object, comprising:
a. designating a portion of an object to be simulated;
b. altering a property value associated with the portion;
c. simulating the designated portion using the altered property value;
d. retrieving or creating an animation corresponding to portions of the object not simulated; and
e. combining the simulated portion and the retrieved or created animation.

2. The method of claim 1, wherein the designating a portion of an object to be simulated includes designating a plurality of control vertices within the object.

3. The method of claim 2, wherein the control vertices are associated with control curves or control surfaces.

4. The method of claim 1, wherein the altering a property value includes altering a variable selected from the group consisting of: stiffness, damping, density, friction, constraints, and force fields.

5. The method of claim 1, wherein the retrieving includes retrieving a cached result of a prior simulation.

6. The method of claim 1, wherein the creating includes retrieving a goal or input mesh.

7. The method of claim 6, wherein the creating further comprises creating an animation based on the goal or input mesh.

8. A non-transitory computer-readable medium, comprising instructions for causing a computing system to perform the method of claim 1.

9. A method of graphically simulating at least a portion of an object, comprising:
a. designating at least a portion of an object to be partially simulated and a first weighting to be associated with the simulation;
b. retrieving or creating an animation corresponding to the designated portion;
c. simulating the designated portion; and
d. blending the retrieved or created animation with the simulation to obtain a final blend, the simulation weighted by the first weighting.

10. The method of claim 9, wherein the designating a portion of an object to be simulated includes designating a plurality of control vertices within the object.

11. The method of claim 10, wherein the control vertices are associated with control curves or control surfaces.

12. The method of claim 9, wherein the simulating includes altering a property value associated with the portion.

13. The method of claim 9, wherein the retrieving includes retrieving a cached result of a prior simulation.

14. The method of claim 9, wherein the creating includes retrieving a goal or input mesh.

15. The method of claim 14, further comprising creating an animation based on the goal or input mesh.

16. The method of claim 9, further comprising designating another portion of the object to be fully simulated, and further comprising combining the fully simulated portion with the final blend to obtain a final result.

17. The method of claim 9, further comprising retrieving or creating an animation corresponding to portions of the object not simulated or partially simulated, and further comprising combining the retrieved or created animation with the final blend to obtain a final result.

18. The method of claim 17, further comprising retrieving or creating an animation corresponding to portions of the object not simulated or partially simulated, and further comprising combining the retrieved or created animation with the final blend and with the fully simulated portion to obtain a final result.

19. The method of claim 9, further comprising combining the simulation with the final blend according to a second weighting.

20. The method of claim 9, wherein the first or second weighting is between zero and one.

21. The method of claim 20, wherein the first or second weighting is a function of location on the portion of an object to be partially simulated.

22. The method of claim 21, wherein the function is a continuous function in each dimension.

23. A non-transitory computer-readable medium, comprising instructions for causing a computing system to perform the method of claim 9.
